(19) United States
(12) Patent Application Publication
(10) Pub. No.: US 2011/0128928 A1
(43) Pub. Date: Jun. 2, 2011

(54) METHOD AND APPARATUS TO IMPROVE CONTENTION BASED TRANSMISSION IN A WIRELESS COMMUNICATION NETWORK

(76) Inventors: Ko-Chiang Lin, Taipei (TW); Yu-Hsuan Guo, Taipei (TW); Meng-Hui Ou, Taipei (TW); Li-Chih Tseng, Taipei (TW)

(21) Appl. No.: 12/956,256

(22) Filed: Nov. 30, 2010

Related U.S. Application Data
(60) Provisional application No. 61/264,848, filed on Nov. 30, 2009.
(60) Provisional application No. 61/285,197, filed on Dec. 10, 2009.
(60) Provisional application No. 61/303,315, filed on Feb. 11, 2010.

(51) Int. Cl. H04W 72/04

(52) U.S. Cl. 370/329

(57) ABSTRACT

A method and apparatus are disclosed to implement Contention Based (CB) transmission in a wireless communication system. The method includes addressing a Physical Downlink Control Channel (PDCCH) to a Contention Based Radio Network Temporary Identifier (CB-RNTI) to identify a plurality of CB uplink (UL) grants on the PDCCH. The method further includes assigning a number of resource blocks (RB) to each CB uplink grant. The method also includes selecting one of the CB uplink grants to transmit a Physical Uplink Shared Channel (PUSCH).

### CROSS-REFERENCE TO RELATED APPLICATIONS

The present Application for patent claims the benefit of U.S. Provisional Patent Application Ser. No. 61/264,848, filed on Nov. 30, 2009, entitled “Method and Apparatus for Improving Contention Based Transmission in a Wireless Communication System”, U.S. Provisional Patent Application Ser. No. 61/285,197, filed on Dec. 10, 2009, entitled “Method and Apparatus of Periodic SRS Transmission from Multiple Antennas and Contention Based Uplink Transmission in a Wireless Communication System”, and U.S. Provisional Patent Application Ser. No. 61/303,315, filed on Feb. 11, 2010, entitled “Method and Apparatus of PDCCH Monitoring for Carrier Aggregation and Contention Based Uplink Transmission in a Wireless Communication System.”

### FIELD

This disclosure relates generally to a method and apparatus to improve Contention Based transmission in a wireless communication network or system.

### BACKGROUND

The goal with Contention Based (CB) transmission is to generally allow uplink synchronized UEs to transmit uplink data without sending Scheduling Request (SR) in advance to reduce both the latency and the signaling overhead. For small data packets, there could be a tradeoff point where a small packet is more efficiently transmitted on a CB channel, compared to a scheduled one. Therefore, in the context of CB transmission, a technique to reduce control signaling overhead for CB transmission, as well as to reduce collision, would be beneficial.

### SUMMARY

A method and apparatus are disclosed to implement Contention Based (CB) transmission in a wireless communication system. The method includes addressing a Physical Downlink Control Channel (PDCCH) to a Contention Based Radio Network Temporary Identifier (CB-RNTI) to identify a plurality of CB uplink (UL) grants on the PDCCH. The method further includes assigning a number of resource blocks (RB) to each CB uplink grant. The method also includes selecting one of the CB uplink grants to transmit a Physical Uplink Shared Channel (PUSCH).

### BRIEF DESCRIPTION OF THE DRAWINGS

FIG. 1 shows a multiple access wireless communication system according to one embodiment of the invention.

FIG. 2 is a block diagram of an embodiment of a transmitter system (also known as the access network (AN)) and a receiver system (also known as access terminal (AT) or user equipment (UE)) according to one embodiment of the invention.

FIG. 3 shows an alternative functional block diagram of a communication device according to one embodiment of the invention.

FIG. 4 is a simplified block diagram of the program code shown in FIG. 3 according to one embodiment of the invention.

FIG. 5 outlines an exemplary flow diagram in accordance with an aspect of the invention.

FIG. 6 illustrates an exemplary implementation in accordance with an embodiment of the invention.

FIG. 7 illustrates an exempl mplementation in accordance with an embodiment of the invention.

FIG. 8 illustrates an exemplary implementation in accordance with an embodiment of the invention.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP2 UMB (Ultra Mobile Broadband), WiMax, or some other modulation techniques.

In particular, the exemplary wireless communication systems and devices described below may be designed to support one or more standards such as the standard offered by a consortium named “3rd Generation Partnership Project” referred to herein as 3GPP, including Document Nos. 3GPP TS 36.321 V9.1.0 (“Evolved Universal Terrestrial Radio Access (E-UTRA) Medium Access Control (MAC) Protocol Specification (Release 9)”), 3GPP TS 36.213 V8.8.0 (“Evolved Universal Terrestrial Radio Access (E-UTRA) Physical layer procedures (Release 8)”), 3GPP TS 36.212 V8.7.0 (“Evolved Universal Terrestrial Radio Access (E-UTRA) Multiplexing and channel coding (Release 8)”), 3GPP TSG-RAN WG2 R2-093812 (“Contention Based Uplink Transmission”), and 3GPP TSG-RAN WG2 R2-096759 (“Details of Latency Reduction Alternatives”). The standards and documents listed above are hereby expressly incorporated herein.

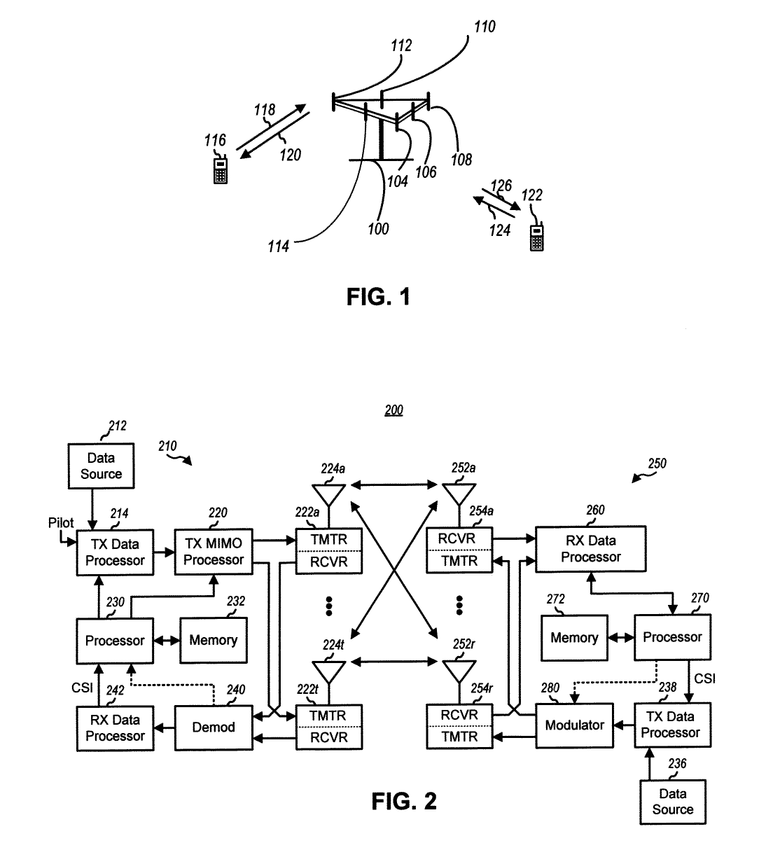

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 utilize beamforming in order to improve the signal-to-noise ratio of forward links for the different access terminals 116 and 124. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

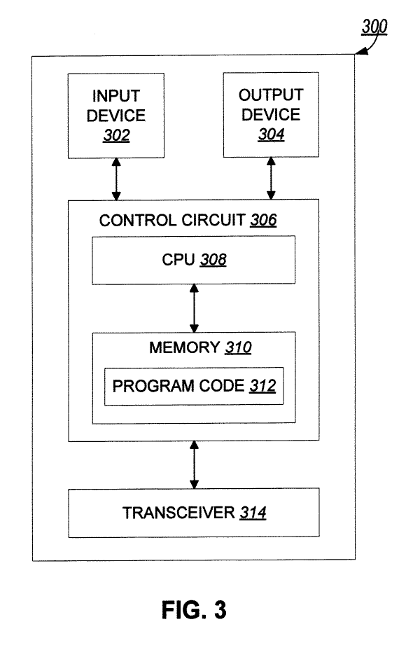

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 106 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

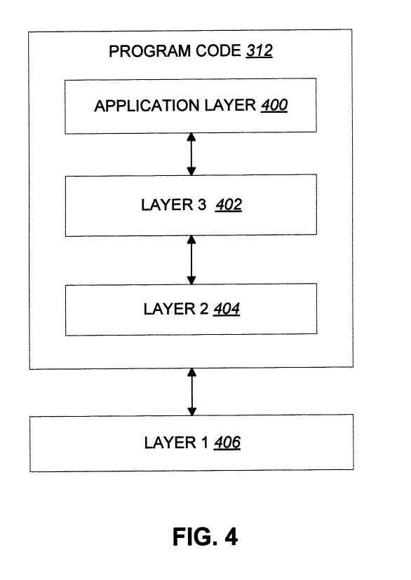

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 406 generally performs link control. The Layer 1 portion 408 generally performs physical connections.

In the following discussion, the invention will be described mainly in the context of the 3GPP architecture reference model. However, it is understood that with the disclosed information, one skilled in the art could easily adapt for use and implement aspects of the invention in a 3GPP2 network architecture as well as in other network architectures.

The concept of Contention Based (CB) transmission was introduced in 3GPP TSG-RAN WG2 R2-093812. In general, the goal with Contention Based (CB) transmission is to allow uplink synchronized UEs to transmit uplink data without sending Scheduling Request (SR) in advance to reduce both the latency and the signaling overhead. For small data packets, there could be a tradeoff point where a small packet is more efficiently transmitted on a CB channel, compared to a scheduled one. A general property of CB channels is that the error rate increases, since data packets may collide with each other. Collisions reduce the maximum throughput of the channel and the throughput becomes sensitive to the offered load. If the offered load is allowed to increase beyond the channel capacity, the collision probability increases rapidly, the system becomes unstable and the throughput decreases. Therefore, CB transmissions do not interfere with Contention Free (CF) uplink transmissions, and the eNodeB has effective and fast means of allocating the resources for CB transmission.

In terms of resource allocation on the PDCCH, 3GPP TSG-RAN WG2 R2-093812 suggests that one way to achieve the above is to allow CB transmission only in uplink Resource Blocks that have not been reserved for CF uplink transmission. Dynamic assignment of uplink Resource Blocks for CB transmission can be achieved by using the Downlink Physical Control Channel (PDCCH). By using the PDCCH, CB grants can be assigned to unused resources on a per subframe basis, so that scheduling of uplink CF transmissions is not affected. In this way, a static assignment of CB resources can be avoided, and CB resources can be dynamically assigned, depending on the uplink load.

3GPP TSG-RAN WG2 R2-093812 also suggests that Contention Based Radio Network Temporary Identifiers (CB-RNTI) are introduced to identify the CB uplink grants on the PDCCH. Among other things, The CB uplink grants could specify Resource Blocks, Modulation and Coding Scheme and Transport Format to be used for the uplink CB transmission. UEs may listen for CB uplink grants addressed to these CB-RNTIs in addition to grants addressed to their dedicated C-RNTI. The available CB-RNTIs in a cell could be either broadcasted or signaled to each UE during RRC connection setup.

In summary, the characteristics of CB transmission are described in 3GPP TSG-RAN WG2 R2-093812 as follows:

The goal of Contention Based (CB) transmission is to transmit uplink data without sending Scheduling Request (SR) in advance to reduce the latency.

A CB transmission may collide with transmissions from other UEs because one CB uplink (UL) grant may be used by multiple UEs simultaneously.

CB UL grants are dynamically assigned by PDCCH (Physical Downlink Control Channel) on a per subframe basis depending on the UL load.

Contention Based Radio Network Temporary Identifiers (CB-RNTI) are introduced to identify the CB UL grants on the PDCCH. The CB-RNTIs could be either broadcasted or signaled to each UE.

A unique UE identifier (ID) is needed in the MAC protocol data unit (PDU) transmitted on the CB UL grant.

A UE should only be allowed to transmit on the CB UL grants if the UE does not have a dedicated UL resource.

In parallel to the CB transmission, the UE can also transmit SRs to request contention free resources. However, in order to maintain the single carrier uplink property, they cannot be transmitted in the same subframe.

Furthermore, in order to realize quick retransmission, 3GPP TSG-RAN WG2 R2-096759 proposed that the following alternatives should be used when the CB transmission fails:

Using PHICH feedback and MAC Local NACK—The MAC Local NACK functionality could be used for CB transmissions to speed up RLC (Radio Link Control) retransmissions. ARQ (Automatic Repeat ReQuest) performance can be improved by utilizing PHICH (Physical Hybrid ARQ Indicator Channel) feedback to indicate successful or unsuccessful transmission. In general, using PHICH means that all UEs attempting transmission on a CB grant will read the same PHICH feedback.

A UE receiving an ACK on PHICH will consider the transmission successful.

A UE receiving NACK on PHICH can issue a local NACK to trigger an RLC retransmission.
A random backoff time could be applied before the local NACK is issued.

Adaptive HARQ—HARQ (Hybrid Automatic Repeat ReQuest) may not be effective when there is a collision. Given the fixed retransmission timing, retransmissions would cause new collisions until one of the UEs reaches the maximum number of retransmissions. However, when there is no collision, i.e. only a single user transmitting on a CB grant, HARQ could be an effective way to correct transmission errors, in the same way as is used for dedicated grants and for Random Access. Furthermore, assuming the eNodeB is able to detect whether a failed CB transmission was caused by collision or due to other reasons (poor link adaptation, UE is power limited, etc), the eNodeB could decide whether to request a HARQ retransmission or RLC retransmission. The basic principle would be to support HARQ when no collision is detected, but to refrain from HARQ if a collision is detected. Thus, unwanted collisions of HARQ retransmissions could be avoided, while still using HARQ gain to correct transmission errors not caused by collision.

In general, if much resource is available in one subframe, it may be desired for the network to transmit multiple grants since CB transmission may not benefit from a large TB (Transport Block) size. However, this requires multiple PDCCH signaling in one TTI (Transmission Timing Interval). If CB grants are to be transmitted in common search space, the already scare space suffers from additional loading. Therefore, a technique is disclosed here to reduce control signaling overhead for CB transmission, as well as to reduce collision. More specifically, the UE should only use part of the resources (such as resource blocks) indicated by the PDCCH so that one PDCCH could carry or facilitate multiple UL grants for the UE to perform CB transmissions.

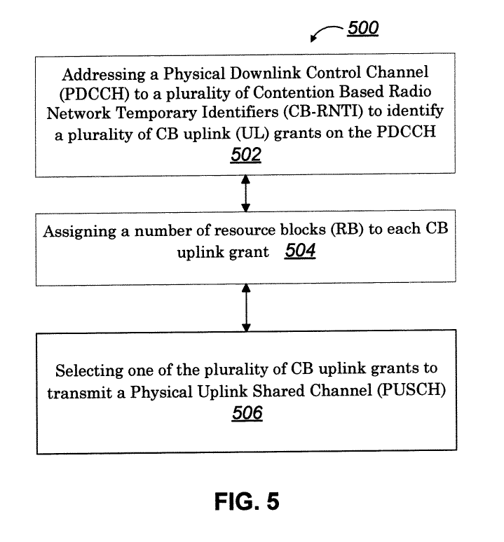

Turning now to FIG. 5, this figure outlines an exemplary flow diagram 500 in accordance with an aspect of the invention. In step 502, a Physical Downlink Control Channel (PDCCH) is addressed to a Contention Based Radio Network Temporary Identifiers (CB-RNTI) to identify a plurality of CB uplink (UL) grants on the PDCCH. In one embodiment, the PDCCH contains DCI format 0 to indicate contiguous resource allocation. In an alternative embodiment, the PDCCH indicates non-contiguous resource allocation. In yet another embodiment, a subset of resource blocks indicated by the PDCCH is treated (and considered by the UE) as one CB uplink grant. In this embodiment, the UE treats other fields (e.g., MCS, cyclic shift) as a normal DCI format.

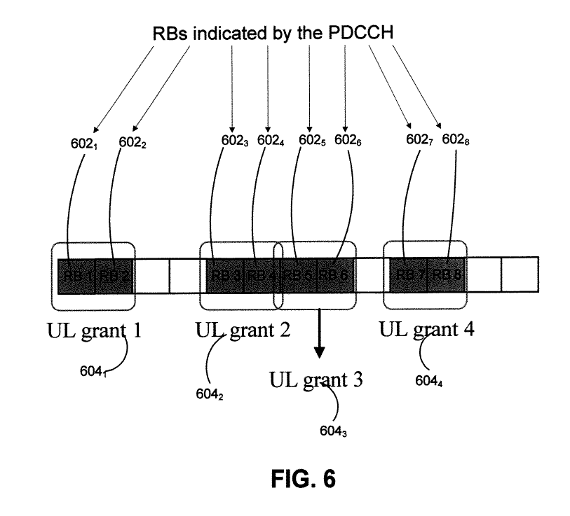

In step 504, a number of resource blocks are assigned to each CB uplink grant. In one embodiment, the number of assigned resource blocks is the same for each CB uplink grant. The number of assigned resource blocks could be a predefined or preconfigured value that is known to the UE. FIG. 6 illustrates an exemplary implementation where the number of assigned resource blocks is a predefined or preconfigured value. As shown in FIG. 6, resource blocks 1 through 8 (corresponding to elements 602₁ through 602₈ respectively) are assigned to UL grants 1 through 4 (corresponding to elements 604₁ through 604₄ respectively). The number of assigned resource blocks is set to two, and there are four UL grants. Each UL grant contains two resource blocks as follows: UL grant 1 604₁ contains RB 1 602₁ and RB 2 602₂, UL grant 2 604₂ contains RB 3 602₃ and RB 4 602₄, UL grant 3 604₃ contains B 5 602₅ and RB 6 602₆, and UL grant 4 604₄ contains RB 7 602₇ and RB 8 602₈.

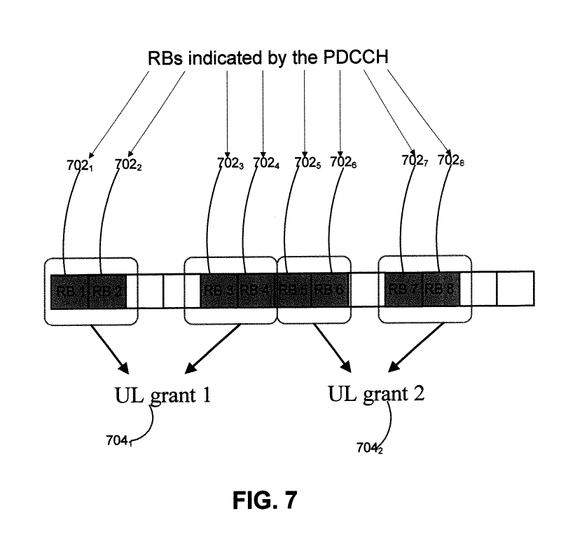

In an alternative embodiment, the number of uplink grants carried by the PDCCH is a predefined or preconfigured value. In this embodiment, the number of available resource blocks is divided by the predefined or preconfigured number of uplink grants, and the result is the number of resource blocks assigned to each uplink grant. FIG. 7 illustrates an exemplary implementation where the number of UL grants is a predefined or preconfigured value. In the example shown in FIG. 7, the number of uplink grants is preconfigured to two, and there are eight available resource blocks. As such, each UL grant contains four resource blocks as follows: UL grant 1 704₁ contains RB 1 702₁, RB 2 702₂, RB 3 702₃, and RB 4 702₄, UL grant 2 704₂ contains RB 5 702₅, RB 6 702₆, RB 7 702₇ and RB 8 702₈.

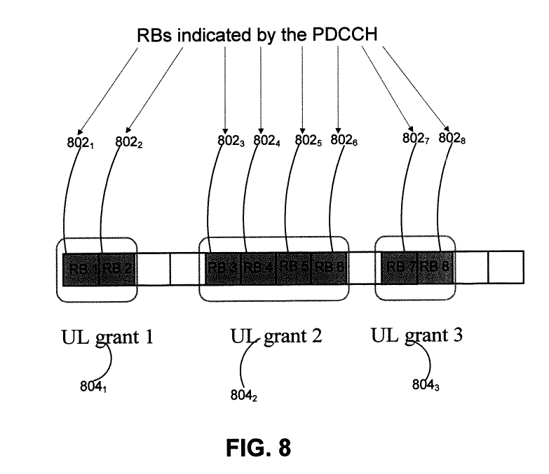

In yet another embodiment, each UL grant is assigned a group or cluster of contiguous resource blocks. FIG. 8 shows an exemplary implementation where clusters of resource blocks are assigned to a UL grant. As shown in FIG. 8, there are three clusters of contiguous resource blocks as follows: the first cluster includes RB 1 802₁ and RB 2 802₂, the second cluster includes RB 3 802₃, RB 4 802₄, RB 5 802₅, and RB 6 802₆, and the third cluster includes RB 7 802₇ and RB 8 802₈. Furthermore, there are three UL grants (including UL grant 1 804₁, UL grant 2 804₂, and UL grant 3 802₃). In this exemplary scenario, UL grant 1 804₁ is assigned and contains resource blocks (RB 1 802₁ and RB 2 802₂) in the first cluster, UL grant 2 804₂ is assigned and contains resource blocks (RB 3 802₃, RB 4 802₄, RB 5 802₅, and RB 6 802₆) in the second cluster, and UL grant 3 802₃ is assigned and contains resource blocks (RB 7 802₇ and RB 8 802₈) in the third cluster.

Turning back to FIG. 5, in step 506, a UL grant is selected by the UE to transmit a Physical Uplink Shared Channel (PUSCH). In one embodiment, the selection of the UL grant could be a random selection. In another embodiment, the selection of the UL grant could be based on some calculation (such as a modular operation) using a predefined or preconfigured offset value. For example, if there are five uplink grantes indicated by the PDCCH, the predefined or preconfigured offset value is three, and a modular operation is used, the third uplink would be selected as the UL grant to transmit the PUSCH as 3 MOD 5 equals 3. In yet another embodiment, the selection of the UL grant to transmit the PUSCH is determined according to the amount of data to be transmitted.

As discussed above, 3GPP TSG-RAN WG2 R2-093812 suggests that in parallel to the CB transmission, the UE can also transmit a SR to request contention free resources. If PUCCH resource for the SR is not configured, the SR would initiate a Random Access (RA) procedure which be performed in parallel with the CB transmission. Techniques are disclosed here to simplify the interaction between the RA procedure and the CB transmission.

In one embodiment, when a RA procedure should be initiated and a CB uplink grant is available, the UE chooses the CB grant for a transmission instead of initiating a random access procedure. However, if no CB grant is available, a random access procedure is initiated. In other aspect, when the RA procedure is on going, the transmission of a RA preamble should be prioritized over the CB transmission. Alternatively, no CB grant should be used for a transmission during the RA procedure. Alternatively, no CB grant should be used for a transmission once the RA preamble is transmitted or a random access response is received during the RA procedure.

In another embodiment, before a random access preamble of a RA procedure can be transmitted or a random access response has not been received, if a CB grant is available (i.e., can be used for a transmission), the UE chooses the CB grant for a new transmission and cancel the RA procedure. Alternatively, the RA procedure should be cancelled when a CB transmission is positively acknowledged.

Furthermore, an issue may arise when a CB uplink grant is collided with a non-empty HARQ buffer. Typically, if a CB uplink grant is always considered to be new, the current HARQ buffer would be overwritten by new data due to CB uplink grant, resulting in unexpected missing data. For example, when HARQ_FEEDBACK=ACK (and not due to CB-RNTI), the UE should not perform non-adaptive retransmission because (1) the data has been successfully received by eNodeB, and (2) eNodeB would likely suspend it temporarily. As another example, when HARQ_FEEDBACK=NACK (and not due to CB-RNTI), the UE should perform non-adaptive retransmission because the data has not been successfully received by eNodeB. In this situation, the CB uplink grant should be ignored (e.g., not monitor CB-RNTI on PDCCH, or detected CB uplink grant should be discarded). The concept is that the status of HARQ buffer is used to help determining whether CB grant is used or whether CB grant is detected by UE. For example, UE would monitor CB-RNTI at a transmission time interval (TTI) at least under one condition that the HARQ buffer associated with the TTI is empty.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method to implement Contention Based (CB) transmission in a wireless communication system, comprising:
addressing a Physical Downlink Control Channel (PDCCH) to a Contention Based Radio Network Temporary Identifier (CB-RNTI) to identify a plurality of CB uplink (UL) grants on the PDCCH;
assigning a number of resource blocks (RB) to each CB uplink grant; and
selecting one of the plurality of CB uplink grants to transmit a Physical Uplink Shared Channel (PUSCH).

2. The method of claim 1, wherein the assigned resource blocks for each CB uplink grant is determined based on that the number of resource blocks assigned to each CB uplink grant is a predefined number.

3. The method of claim 1, wherein the assigned resource blocks for each CB uplink grant is determined based on a predefined number of CB uplink grants carried by the PDCCH and by available resource blocks.

4. The method of claim 1, wherein each CB uplink grant is assigned a cluster of contiguous resource blocks.

5. The method of claim 1, wherein the selection of one of the plurality of CB uplink grants to transmit a Physical Uplink Shared Channel (PUSCH) is determined by random selection.

6. The method of claim 1, wherein the selection of one of the plurality of CB uplink grants to transmit a Physical Uplink Shared Channel (PUSCH) is performed based on an amount of data to be transmitted.

7. The method of claim 1, wherein the selection of wherein the selection of one of the plurality of CB uplink grants to transmit a Physical Uplink Shared Channel (PUSCH) is done by performing a calculation using a predefined offset value.

8. The method of claim 1, wherein the PDCCH uses DCI format 0 to indicate contiguous resource allocation.

9. The method of claim 1, wherein the PDCCH indicates non-contiguous resource allocation.

10. The method of claim 1, wherein each UL grant is assigned a same number of resource blocks.

11. A method to implement Contention Based (CB) transmission in a wireless communication system, comprising:
addressing a Physical Downlink Control Channel (PDCCH) to a Contention Based Radio Network Temporary Identifier (CB-RNTI) to identify a CB uplink (UL) grant on the PDCCH; and
deciding whether to use the CB uplink grant for transmission or to initiate a random access (RA) procedure.

12. The method of claim 11, wherein the step of deciding whether to use the CB uplink grant for transmission or to initiate the random access (RA) procedure further comprises:
choosing the CB uplink grant for transmission and not initiating the RA procedure when the RA procedure should be initiated and the CB uplink grant is available.

13. The method of claim 11, wherein the step of deciding whether to use the CB uplink grant for transmission or to initiate the random access (RA) procedure further comprises:
initiating the RA procedure when the RA procedure should be initiated and the CB uplink grant is not available.

14. The method of claim 13, further comprises:
prioritizing a transmission of a RA preamble over a CB transmission when the RA procedure is ongoing.

15. The method of claim 13, further comprises:
disallowing use of any CB grant for transmission while the RA procedure is ongoing.

16. The method of claim 13, further comprises:
choosing a CB uplink grant for transmission if the CB uplink grant becomes available before a random access preamble of the RA procedure is transmitted.

17. The method of claim 13, further comprises:
choosing a CB uplink grant for transmission if the CB uplink grant becomes available before a random access response is received.

18. A method to implement Contention Based (CB) transmission in a wireless communication system, comprising:
addressing a Physical Downlink Control Channel (PDCCH) to a Contention Based Radio Network Temporary Identifier (CB-RNTI) to be able to identify a CB uplink (UL) grant on the PDCCH; and
deciding whether to allow or to disallow monitoring CB-RNTI on the PDCCH at a first transmission time interval (TTI) when a non-empty Hybrid Automatic Repeat ReQuest (HARQ) buffer is associated with the first TTI.

19. The method of claim 18, further comprises:
disallowing monitoring CB-RNTI on the PDCCH when HARQ_FEEDBACK associated with the non-empty HARQ buffer is NACK.

20. The method of claim 18, further comprises:
allowing monitoring CB-RNTI on the PDCCH when HARQ_FEEDBACK associated with the non-empty HARQ buffer is ACK.
